(19) United States
(12) Patent Application Publication
(10) Pub. No.: US 2007/0079847 A1
(43) Pub. Date: Apr. 12, 2007

(54) Oral hygiene apparatus

(76) Inventor: Mark A. Sampson, Titusville, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 11/514,398

(22) Filed: Aug. 23, 2006

Related U.S. Application Data
(63) Continuation-in-part of application No. 10/215,349, filed on Aug. 8, 2002, now Pat. No. 7,156,109.

(51) Int. Cl. A61C 15/00

(52) U.S. Cl. 132/323

(57) ABSTRACT

A frame facilitating dental floss-based tooth cleaning and oral and vaporous administration of medication has two pieces, each with surfaces adapted for facing contacting securement one to another, with plurality of male and female members located on the facing surfaces for mating engagement as the pieces are assembled to form the frame, with the male members being adapted to puncture, if needed, and to retain a medication impregnated web in place, as the male members enter the female members with the web is positioned therebetween.

### CROSS REFERENCE TO RELATED PATENT APPLICATION

This patent application is a continuation-in-part under 35 U.S.C. 120 of U.S. patent application Ser. No. 10/215,349, filed 8 Aug. 2002 in the name of Mark A. Sampson and entitled “Smoking Cessation Oral Hygiene Device”.

### BACKGROUND OF THE INVENTION—FIELD OF THE INVENTION

In one of its aspects this invention relates to an improved combination tooth pick/dental floss appliance, with the addition of a medicament pad. In another one of its aspects this invention provides apparatus facilitating dental floss-based tooth cleaning and oral and vaporous administration of medication, where the medication may be a nicotine-based drug to promote smoking cessation, a fluoride-based tooth enamel hardener, a breath freshener, a base for neutralizing stomach acid, a stomach acid inhibitor, a tooth enamel whitener, some combination of the foregoing or some other therapeutic substance. The apparatus combines dental floss application with oral and vaporous administration of medication.

### BACKGROUND OF THE INVENTION—DESCRIPTION OF THE PRIOR ART

An ever more important factor for acceptance and success in society today is our ability to interact and communicate with others. Success in this highly interactive world mandates much of each person. Cleanliness, proper dress, good hair grooming, as well as control over other's perception of one's breath are always required. An important part of social acceptance depends on the appearance of one's teeth, freshness of one's breath, and overall oral hygiene. It is not uncommon to be in a confined situation with others and be totally unprepared concerning one's oral state.

A large percentage of the population, namely the baby boomer generation was taught both in school and at home of the importance of brushing teeth. That generation for the most part was introduced later to benefits of using dental floss. Many still have fear and misunderstanding of flosses and flossing tools.

The benefits of dental floss, such as controlling gum disease, fighting bad breath, and aiding in plaque removal, are unquestioned. It only makes sense that more and more of the population find a method for using floss that is suited to them.

Over time many different approaches have been used in development of floss containers and applicators. Prior art reflects development of many products, ranging from simple spool-like products to complex floss applicators with built in storage compartments. An example of complex flossing apparatus is U.S. Pat. No. 5,423,338 to Hodge, which discloses a device shaped similarly to an electric toothbrush that holds the dental floss in a sealed enclosure to prevent contamination of unused floss. This product is not easily transported; it is suitable for a stationary environment

Situations arise where it is impractical, whether due to time constraints or physical location, for a person to brush or to floss one's teeth using a large appliance such as disclosed in the '338 patent. The '338 patent device and others like it create a terrible disadvantage for those persons unable to stop their daily activities in order to find facilities in which to use products such as the '338 device.

A major category of previous flossing devices are disposable flossing tools; one such tool is disclosed in U.S. design Pat. No. 279,826, issued to Schindler. Some of the advantages of this category of tools include ease of use, portability, compact size and affordability.

A disadvantage of many prior art flossing and floss holding devices is the inability to act as a delivery system for medication.

### SUMMARY OF THE INVENTION

In one of its aspects this invention provides a smoking cessation and oral hygiene device facilitating tooth cleaning using dental floss. The device can used as a smoking cessation device or an oral hygiene device, depending on the desire of the user. In this aspect of the invention the device employs one-piece integral construction, with an elongated handle tapering from a floss and medicament holding end to a remote pointed toothpick end. The floss and medicament end preferably forms the base of a U-shaped portion having extremities in the form of parallel legs. The legs are preferably deformable to allow for placement of a medicament, preferably in the form of an impregnated pad, therebetween and are preferably spaced apart the width of a large adult's 12 year old molar. The U-shaped portion is preferably sufficiently small to fit easily into the mouth of an adolescent. Dental floss is preferably connected to and extends between the legs of the preferably U-shaped portion in a position spaced from an extension portion of an elongated handle forming a base of the U-shaped portion.

A saliva-soluble orally administrable hygienic medicament-impregnated pad is preferably secured to the U-shaped portion. The medicament pad can be a nicotine delivery system, which preferably reduces and thereafter eliminates the craving for nicotine and hence the desire to smoke. Use of a series of medicament pads, each having a reduced amount of nicotine, weans the smoker from the biochemical craving associated with smoking.

In this aspect the invention preferably not only satisfies the biochemical craving associated with nicotine but also simulates the physical act of smoking when the elongated handle is placed between the user's finger tips. Combining the oral hygiene tool with a smoking cessation device is desirable because smoking is a pleasant, habitual activity after eating, when teeth need to be cleaned.

The invention in this one of its aspects is not limited to use by smokers. A non-smoker may use a mint-type, flavored medicament, which will freshen the breath; an antacid medicament, which will reduce acid reflux as experienced by many; or a fluoride medicament, which will help prevent cavities. The variety of flavors and ingredients in the medicament pad encourages use of the device and therefore flossing, resulting in improved oral hygiene.

In a second one of its aspects this invention provides apparatus facilitating dental floss-based tooth cleaning and oral and vaporous administration of medication, where the apparatus includes a frame of preferably two piece construction having an inhalation end and a floss and medicament holding end. The frame preferably includes two pieces, preferably having mirror image surfaces, that are preferably adapted for preferably facingly contacting securement one to another. Each piece preferably includes a longitudinally elongated handle portion preferably extending from a floss and medicament holding end to an inhalation end, with a longitudinally extending depression preferably running the length of the handle portion of each piece. The longitudinally extending depression is preferably formed in the mirror image surface of the handle portion so that when the mirror image surfaces of the two handle portions complementally contact and overlie one another, as the two pieces are assembled to define the frame, the facing depressions preferably define an interior air drawing passageway extending the longitudinal length of the handle.

The frame preferably further includes a U-shaped portion formed at the floss and medicament holding end, having the base of the U defined by a portion of the handle remote from the inhalation end. Legs of the U extend preferably parallel and preferably transversely from the handle and are preferably adapted to retain dental floss stretched tautly therebetween at a location proximate to the leg extremities that are remote from the handle portion defining the base of the U. The U-shaped portion is desirably sufficiently small to fit easily into the mouth of an adolescent, with the legs of the U being spaced apart more than the width of a large male adult's 12 year molar.

The frame still further preferably includes a plurality of protrusions and receptacles, with the protrusions preferably being located on the mirror image surface of the first one of the pieces and the receptacles preferably being located in and correspondingly positioned on the mirror image surface of the remaining one of the pieces. The receptacles serve to receive and preferably releasably retain corresponding ones of the protrusions as the pieces are assembled into the frame. The protrusions preferably are further adapted to puncture, if needed, and to retain a medicament web in place as the protrusions enter the receptacles. The web is preferably positioned between and in facing contact with the mirror image surfaces of the pieces as the pieces are assembled into the frame.

The apparatus further preferably includes dental floss connected to and extending between the legs of the U, proximate extremities thereof that are spaced from the part of the handle forming the base of the U.

The medicament web preferably has a saliva-soluble orally administerable medication as a part thereof, with the web preferably being sandwiched between the mirror image surface portions of at least the legs of the U when the mirror image surfaces of the two U-shaped portions facingly contact, with the web occupying longitudinally elongated space separating the legs of the U and extending transversely substantially to the base of the U.

The medication deliverable using the apparatus in this aspect of the invention preferably includes at least one of a nicotine based therapeutic drug used to inhibit smoking, a fluoride based tooth enamel hardener, a breath freshener, a base for neutralizing stomach acid, a stomach acid inhibitor, and a tooth enamel whitener.

In still another one of its aspects this invention provides a smoking cessation apparatus facilitating dental floss-based tooth cleaning and oral hygiene where the apparatus has a frame which includes an elongated handle extending from a floss and medicament holding end to a preferably pointed toothpick end. The floss and medicament holding end is of U-shape and preferably formed as an extension portion of the handle, with legs of the U preferably retaining dental floss therebetween, with the floss and medicament holding end preferably being sufficiently small to fit easily into the mouth of an adolescent, and with the legs of the U preferably being adapted to tautly retain therebetween a length of dental floss greater than the width of a large male adult's 12 year molar.

In this aspect of the invention the apparatus preferably further includes dental floss connected to and extending between the legs of the U and being spaced from the portion of the handle forming the base of the U, a saliva-soluble orally administered hygienic medicament that is securable to the U-shaped portion, and an air drawing tube extending the length of the elongated handle, where the U-shape preferably includes a first mating surface and the medicament preferably includes a second mating surface, with the mating surfaces being adapted for complementally contactingly engaging one another to retain the medicament in position within the U.

In still yet another of its aspects this invention provides a frame for facilitating dental floss-based tooth cleaning and oral and vaporous administration of medication, with the frame preferably having two pieces each with surfaces adapted for facingly contacting securement one to another to form the frame. Each piece of the frame preferably includes longitudinally elongated handle. At least one of the frame pieces preferably includes a portion formed proximate one end of the handle having legs extending parallel one with another and transversely from the handle, and further being adapted to tautly retain dental floss therebetween proximate the leg extremities that are remote from the handle. This portion is preferably sufficiently small to fit easily into the mouth of an adolescent with the legs that are parallel one with another being spaced apart more than the width of the large male adult 12 year molar.

The frame further preferably includes a plurality of male and female members preferably located on facing surfaces of the frame pieces for mating engagement as the pieces are assembled to form the frame, with the male members being adapted to puncture, if needed, and to retain a medication impregnated web in place, with at least a portion of the web being preferably between the legs, as the male members enter the female members when the web is positioned therebetween. The web remains in contact with the facing surfaces of the pieces as the pieces are assembled to form the frame.

In yet an additional one of its aspects this invention provides a dental floss-based tooth cleaning and oral vaporous medication administration product provided in a package. Within the package preferably is a frame preferably constructed of two pieces adapted for contacting securement one to another with the frame preferably including a longitudinally elongated handle. The frame further includes a preferably U-shaped portion having the base of the U defined by a portion of the handle, with legs of the U preferably extending parallel and transversely from the handle and being adapted to retain dental floss stretched therebetween. The U-shaped portion is preferably sufficiently small to fit easily into the mouth of an adolescent, with the legs of the U preferably being spaced apart more than the width of a large male adult twelve year molar. A protrusion is provided on one of the pieces while a receptacle is provided on the remaining one of the pieces, with the two pieces being adapted to retain a medicament web in place therebetween as the protrusion enters the receptacle with the web positioned between and in contact with the pieces, as the pieces are assembled into the frame.

Within the package is further included dental floss adapted for connection to and extending between the legs of the U.

The contents of the package preferably further include a medicament web preferably having saliva soluble, orally administrable medication therein, where the web is adapted to be sandwiched between portions of at least legs of the U when surfaces of the U-shaped parts of the two pieces facingly contact. In such configuration the web substantially occupies the longitudinally elongated space separating the legs of the U and extends transversely substantially to the base of the U. The medication in the medicament web may include at least one of a nicotine-based drug to promote smoking cessation or at least smoking reduction, a fluoride-based tooth enamel hardener, a breath freshener, a base for neutralizing stomach acid, a stomach acid inhibitor and a tooth enamel whitener, or another therapeutic substance.

### BRIEF DESCRIPTION OF THE DRAWINGS

FIG. 1 is a side view of a smoking cessation device embodying aspects of the invention, with no medicament impregnated pad in place.

FIG. 2 is a side view of a medicament pad adapted to fit into the device illustrated in FIG. 1.

FIG. 3 is a top view of the medicament pad shown in FIG. 2, illustrating a beveled edge of the pad and an at least partially circumferential groove formed in the edge of the pad.

FIG. 4 is a top view of the smoking cessation device illustrated in FIG. 1.

FIG. 5 is a longitudinal sectional view of the smoking cessation device illustrated in FIG. 1, with the section taken at lines 1-1 in FIG. 1.

FIG. 6 is a front elevation of a first frame piece of a frame portion of apparatus facilitating dental floss-based tooth cleaning and oral and vaporous administration of medication, manifesting aspects of the invention.

FIG. 7 is a view of the bottom of the first frame piece illustrated in FIG. 6, looking upward from below relative to FIG. 6.

FIG. 8 is a left side view of the front frame piece illustrated in FIGS. 6 and 7, looking from the left in FIG. 7.

FIG. 9 is a front elevation of a second frame piece of a frame portion of apparatus facilitating dental floss-based tooth cleaning and oral and vaporous administration of medication, manifesting aspects of the invention.

FIG. 10 is a view of the top of the second frame piece illustrated in FIG. 9, looking downwardly on the second frame piece from above relative to FIG. 9, with a length of dental floss in place.

FIG. 11 is a left side view of the second frame piece illustrated in FIGS. 9 and 10, looking from the left in FIG. 10.

FIG. 12 is a plan view of a medicament web adapted for use with the frame pieces illustrated in FIGS. 6 through 11.

FIG. 13 is a side view of the assembled apparatus facilitating dental floss-base tooth cleaning and oral vaporous administration, illustrating the assembled condition of the pieces illustrated in FIGS. 6 through 12.

FIG. 14 is a top view of the assembled apparatus facilitating dental floss-base tooth cleaning and oral vaporous administration and medication illustrated in FIG. 13.

### DETAILED DESCRIPTION OF THE PREFERRED EMBODIMENTS AND BEST MODE KNOWN FOR PRACTICE OF THE INVENTION

Referring to FIGS. 1 through 5, a smoking cessation oral hygiene device, embodying aspects of the invention, is designated generally 10 and is, other than dental floss and a medicament pad described below, preferably of one-piece integral construction. Device 10 includes an elongated handle 12, with a top 14 and a bottom 16, and tapers from a floss and medicament holding end designated generally 18 to a remote pointed toothpick end 20. An air drawing tube 22, having a proximal end 24 and a distal end 26, is integrally formed within the top 14 of elongated handle 12.

A U-shaped portion designated generally 28 in part defines the floss and medicament holding end 18 and has a base 30 of the U formed as a transversely extending portion of handle 12. Leg extremities of U-shaped portion 28 are defined as proximate leg 32 and distal leg 34 extending from and connected to base 30, and are adapted to retain dental floss 36 preferably stretched therebetween. Legs 32, 34 extend transversely from and with respect to handle 12 and, as illustrated in FIG. 1, are preferably parallel one with another and preferably both extend the same distance from handle 12. U-shaped portion 28 is preferably sufficiently small to fit easily into the mouth of an adolescent. Proximate leg 32 and distal leg 34 of U-shaped portion 28 are preferably structurally deformable so that these members may bend and deform upon contacting a user's teeth, gums or other oral structure, thereby to prevent injury to the user when using apparatus 10, and are preferably spaced apart the width of a large male adult 12 year molar.

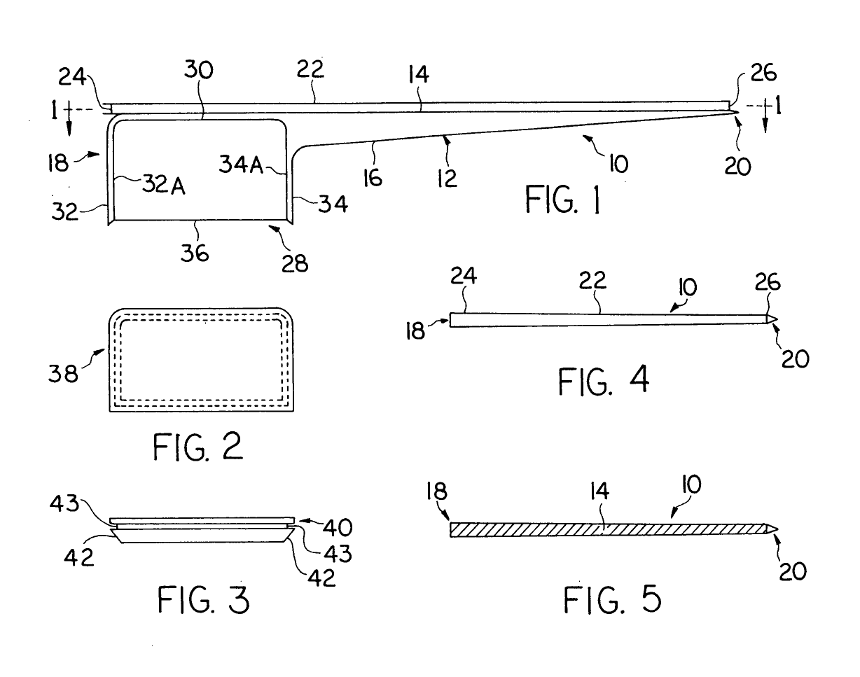

As illustrated in FIGS. 2 and 3, the medicament pad 38 may be formed as two disk-configured halves 40, which are preferably joined with an edible adhesive (not shown) and which preferably fit within, and attach to, U-shaped portion 28. Medicament pad 38 can have a beveled edge 42 around the sides of one of the disk halves 40 with an undercut groove 43 preferably provided inboard of beveled edge 42, with groove 43 formed to be complemental to a bead-like structure on the inwardly facing exterior surfaces 32A, 34A of legs 32, 34 and inwardly facing (relative to the interim portion of the “U” shape) exterior surface 30A of base 30 of U-shaped portion 28. The bead-like structure which may be provided on inwardly facing exterior surfaces 32A, 34A and 30A has not been illustrated in the drawings.

As an alternative to the bead-like structure, inwardly facing exterior surfaces 32A, 34A and 30A may be configured with a tapered, almost knife-like shape so as to fit within groove 43 formed in medicament pad 38, thereby to retain medicament pad 38 within U-shaped portion 28. Such a configuration allows mating of inwardly facing exterior surfaces 32A, 34A and 30A of legs 32 and 34 and base 30 with undercut groove 43, which is preferably inboard of beveled edge 42 of medicament pad 38. The mating surfaces of legs 32A, 34A, base 30A and medicament pad 38 can be any of a variety of complementary configurations, such as V-shaped or U-shaped.

Other possible methods of attaching medicament pad 38 include dipping device 10 into a liquid solution of the desired medicament coating to form medicament pad 38. When the proper coating thickness is achieved, device 10 is left to dry and the result is a device 10 with a dissolvable coating. This technique is much like that experienced when a child blows bubbles. Using this approach the U-shaped portion of the device is dipped repeatedly into the solution and the solution forms a web in the interior of the U as the solution adheres to the three sides of the U-shape, and to dental floss 36 if the floss is in place between legs 32 and 34.

The unnumbered outer extremities of legs 32 and 34 are preferably equipped with undercuts, proximate the distal tips of legs 32, 34 relative to handle 14, so that dental floss may be wrapped around the extremity tips of legs 32, 34 and retained in place by the undercuts. Alternatively, the outer ends of legs 32, 34 may be formed with slits, with the floss inserted into the slits and retained thereby. As a further alternative, the floss may be retained and connected to the extremities of legs 32, 34 by adhesive, or by other mechanical securing means such as by small tabs that are molded in place or otherwise attached to the extremities of legs 32, 34.

Other physical attachment methods for the medicament pad are known and depend on the particular medicament being used. The particular attachment method used with a particular medicament is selected so that manufacture of the device is practical and economically viable. In a preferred construction of the device illustrated in FIGS. I through 5, dental floss 36 is in place and is outboard of medicament pad 38. Hence, as a user flosses one's teeth with dental floss 36, pad 38 necessarily comes into contact with the user's teeth and gums, and with saliva in one's mouth, so that the medication from pad 38 is administered orally, and partially nasally through breathing through one's nose, as the medication in pad 38 dissolves and vaporizes within the user's mouth.

In FIG. 1 arrow 38 denotes that the medicament pad may be in place within the interior of the U as dental floss 36 is positioned across the extremities of legs 32, 34. Use of dental floss 36 and administration of medication from pad 38 desirably occur simultaneously. It is less desirable, but possible, to perform the dental flossing function initially and thereafter place pad 38 in position to administer the medication.

Device 10 is most often and desirably used after eating by grasping the U-shaped portion 28, placing the elongated handle 12 into the user's mouth and removing residual food material by using toothpick end 20 in the normal, acceptable manner. Thereafter, the user removes device 10 from the user's mouth, grasps the toothpick shaped end 22 and uses dental floss 36 in the usual manner to floss one's teeth. As the user is flossing, medicament pad 38 is dissolved by saliva and by contact with the interior of the mouth.

In the embodiment illustrated in FIGS. 1 through 5, when device 10 is being used to reduce or eliminate smoking, oral anti-smoking medications such as nicotine based drugs preferably are in pad 38. Therapeutic substances in medicament pad 38 are preferably released by “sucking action” of the mouth as the user simulates smoking preferably by drawing air through the air drawing tube 22 integral with elongated handle 12. Simultaneously, elongated handle 12 is preferably being grasped by the fingers of the user. Inhalation of the therapeutic substance(s) in medicament pad 38 and grasping of elongated handle 12 of device 10 together satisfy both the biochemical cravings and physical behavior characteristics associated with smoking, enabling the smoker to eliminate the behavior.

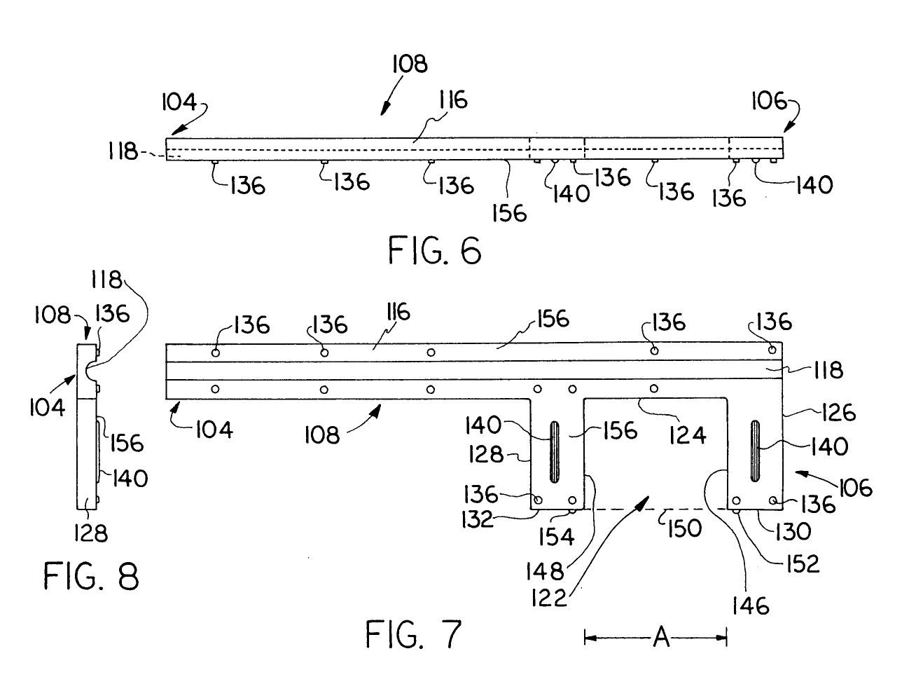

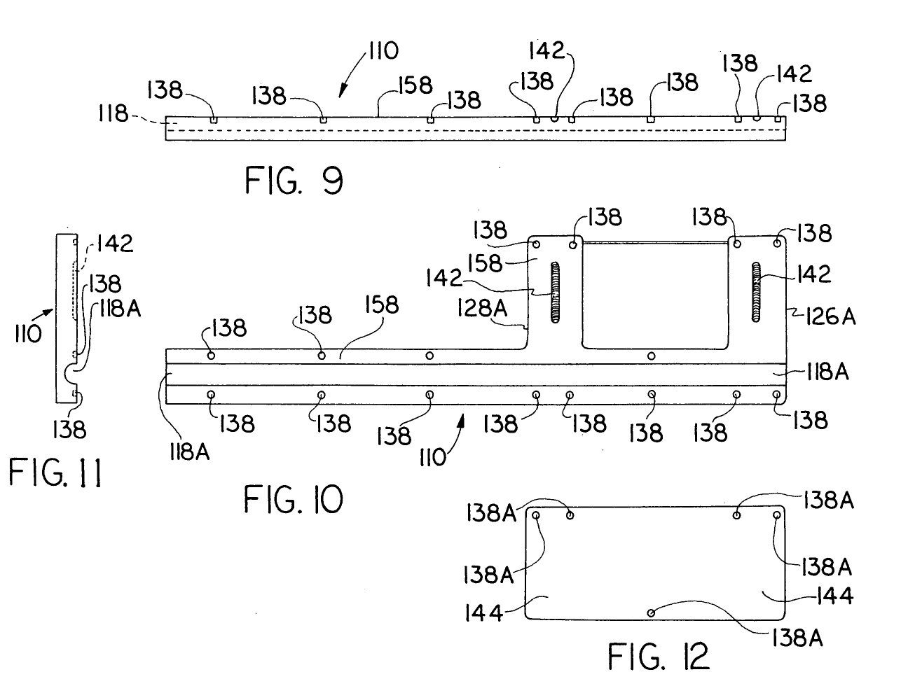

Referring to FIGS. 6 through 11, in another aspect of the invention apparatus facilitating dental floss-based tooth cleaning and oral and vaporous administration of medication includes a frame of two-piece construction having a first frame piece designated generally 108 and a second frame piece designated generally 110, where first frame piece 108 is illustrated in FIGS. 6, 7 and 8 and second frame piece 110 is illustrated in FIGS. 9, 10 and 11. Frame pieces 108, 110 connect together to form frame 102.

Referring specifically to FIGS. 6, 7 and 8, first frame piece 108 has an inhalation end designated generally 104 and a floss and medicament holding end designated generally 106. First frame piece 108 includes a longitudinally elongated handle portion 116 extending from floss and medicament holding end 106 to inhalation end 104. The lower surface of first frame piece 108 illustrated in FIG. 7 includes a longitudinally elongated depression 118 extending the length of handle portion 116, as illustrated in the drawing. Longitudinally elongated depression 118 is of semi-circular shape preferably having a substantially continuously and completely curved interior surface as shown in FIG. 8.

First frame piece 108 is fabricated to include a U-shaped portion designated generally 122 where a part of handle portion 116 forms a base 124 of U-shaped portion 122. U-shaped portion 122 has a first leg designated generally 126 and a second leg designated generally 128, both of which extend transversely from handle portion 116 and are parallel one to another as illustrated in FIGS. 7 and 8. First and second legs 126, 128 are also coplanar with handle portion 116 as is apparent from FIGS. 6 and 8. An extremity of leg 126 relative to handle 116 is designated 130 and a similar extremity of leg 128 relative to handle 116 is designated 132. Legs 126, 128 are positioned spaced apart from one another a distance indicated by dimensional arrow A in FIG. 7 that is at least equal to the width of a large adult male's 12 year molar.

An external surface of first leg 126 that faces interiorly respecting U-shaped portion 122 is designated 146 while a corresponding external surface of second leg 128 that faces inwardly respecting the U of U-shaped portion 122 is designated 148. Surfaces 146 and 148 must be sufficiently spaced apart, as indicated by dimensional arrow A in FIG. 8, to allow dental floss stretched between first and second legs 126, 128 to fit between one's teeth as an adult male endeavors to floss adjacent to his 12 year old molar. If distance between facing surfaces 146, 148 represented by dimensional arrow A in FIG. 7, is less than the width of a large male's 12 year molar, a adult user of apparatus 100 will find it impossible to fit the floss between the 12 year molar and an adjacent tooth and thus will not be able to perform the flossing function and obtain the therapeutic benefits flossing provides.

For flossing, dental floss is designated schematically by dotted line 150 in FIG. 8 is positioned between extremities 130 and 132 of legs 126 and 128. Dental floss 150 may be secured to respective extremities 130, 132 by adhesive, or by wrapping around small tabs which may be molded in place if first frame piece 116 is a plastic molded piece or which may be mechanically attached as first frame piece 108 is fabricated. Two such tabs are indicated schematically as 152, 154 with one tab being on the outwardly facing surface defining extremity 130 of leg 126 and the second tab 154 being the outwardly facing surface of extremity 132 of leg 128.

As seen in FIGS. 6, 7 and 8, first frame piece 108 is of essentially rectangular appearance and configuration in that all of the external surfaces of first frame piece 108 are preferably planar and, with the exception of protrusions 136 extending from a lower surface 156 and the exception of male alignment guides 140 also extending from lower surface 56, all of the external surfaces of first frame piece 108 are preferably planar.

Male alignment guide 140 preferably protrudes from surface 136 as illustrated in FIGS. 6, 7 and 8 and is preferably traversely elongated relative to handle portion 116 of first frame piece 108. Transverse elongation of male alignment guide 140, with two male alignment guides 140 preferably being provided, one being located on each of legs 126, 128 of U-shaped portion of first frame piece 108, assures alignment between first frame piece 108 when assembled with second frame piece 110. Alignment results since male alignment guides 140 fit into corresponding female alignment grooves 142 formed in corresponding positions of second frame piece 110. Female alignment grooves 142 are illustrated in FIGS. 9, 10 and 11.

Lower surface 156 of first frame piece 108 is preferably smooth and is preferably a mirror image of a corresponding upper surface 158 of second frame piece 110, as illustrated in FIGS. 9, 10 and 11. Lower surface 156, being planar, extends over the entirety of the portion of handle 116 and U-shaped portion 122 of first frame piece 108 facing the viewer in FIG. 7; the only portions of lower surface 156 of first frame piece 108 that is not planar, when viewing first frame piece 108 in the position illustrated in FIG. 7, are protrusions 136, male alignment guides 140 and longitudinally extending depression 118. This planar characteristic of lower surface 156 of first frame piece 108 is especially well-shown in FIGS. 6 and 8.

Protrusions 136 are formed along the length of handle portion 116, on either side of longitudinally extending depression 118 in mirror image lower surface 156.

Referring now to FIGS. 9 through 11, a second frame piece 110 is illustrated, which forms the bottom portion of frame 102 when assembled together with first frame piece 108 illustrated in FIGS. 6 through 8. Second frame piece 110 is in many ways a mirror image of first frame piece 108, but with receptacles 138 preferably provided in positions corresponding to those of protrusions 136 on first frame piece 108, and with female alignment grooves 142 preferably provided in positions corresponding to those of male alignment guides 140 on first frame piece 108. Further similarly to first frame piece 108, the surface of second frame piece 110 in which receptacles 138 and female alignment grooves 142 are formed, namely upper surface 158 of second frame piece 110, is preferably planar and essentially a mirror image of lower surface 156 of first frame piece 108.

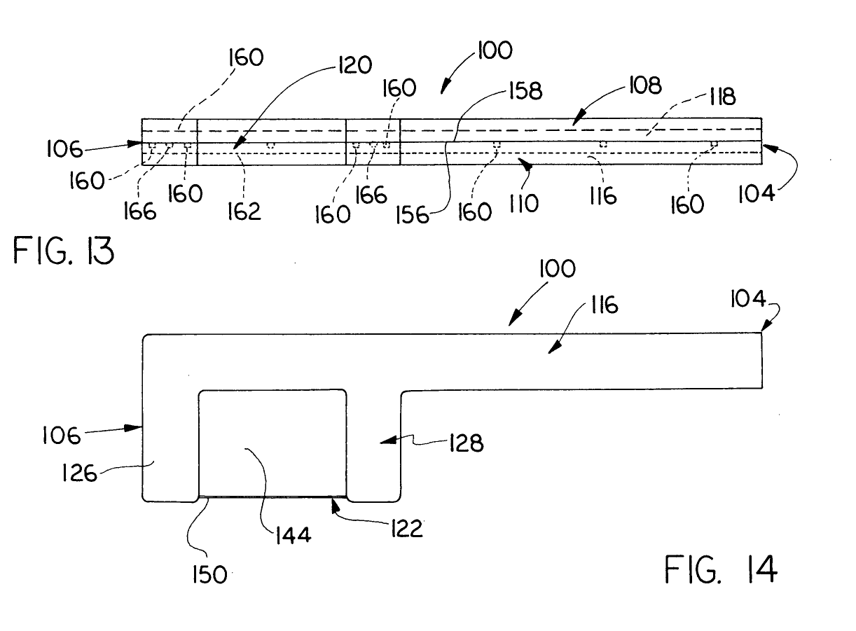

FIG. 12 illustrates a medicament web adapted to be held in position between first frame piece 108 and second frame piece 110 when those two frame pieces are assembled into frame 102, as illustrated in FIGS. 13 and 14. Medicament web 144 may be entirely solid, namely without apertures, in which case medicament web 144 is preferably placed in position between first and second frame pieces 108, 110 as those two frame pieces are assembled by being pushed together to form frame 102. As frame pieces 108, 110 are pushed together, protrusions 136 preferably penetrate medicament web 144 as those protrusions 136 enter receptacles 138 in second frame piece 110, which receptacles are aligned with protrusions 136 and located beneath medicament web 144.

More desirably, medicament web 144 is preferably fabricated in shape and size to fit flushly between first and second frame pieces 108, 110 so there is no overhang of medicament web 144 outside the periphery of frame 102 when frame 102 is assembled. Further desirably, in such case medicament web 144 is preferably fabricated with apertures 138A already formed in web 144 so that those apertures may fit over corresponding receptacles 138A or fit around corresponding protrusions 136. If apertures 138A are fabricated so that medicament web 144 has protrusions 136 fitting through apertures 138A, medicament web 144 will desirably be held in place by frictional contact between protrusions 136 and apertures 138A thereby further facilitating assembly of frame 102 into apparatus 100.

Referring to FIGS. 13 and 14, apparatus 100 in its assembled condition is shown with a medicament pad 144 and a length of dental floss 150 in position as shown in FIG. 14. In the assembled condition, apparatus 100 desirably presents only flat exterior surfaces, as illustrated in FIGS. 13 and 14, thereby facilitating cleaning of apparatus 100 when the apparatus is disassembled for removal and replacement of dental floss 150 and/or replacement of an exhausted, preferably dissolved, medicament pad 144 with a new pad of medicament film or that is impregnated with medication. Medicament pad 144 is preferably entirely soluble in saliva so that as the user flosses one's teeth, pad or film 144 dissolves thereby medicating the user by the user swallowing the dissolved medication and, to some extent, inhaling the medication as vapors escape from the user's mouth and enter the user's nasal passageways.

Further respecting the assembly of apparatus 100, protrusions 136 residing in receptacles 138 are denoted by number 160 as protrusions being resident in receptacles, where this illustrated in FIG. 13.

Similarly, the top and the bottom of passageway 120 extending the longitudinal length of apparatus 100 are denoted by dotted lines 162, 164 in FIG. 13. Passageway 120 is preferably circular in cross-section as defined by the semi-circular depressions 118, 118A illustrated in FIGS. 7, 8, 10 and 11.

In the assembled condition of frame 102 and apparatus 100 as illustrated in FIG. 13, lower surface 156 of first frame piece 108 is in complemental facing contact with upper surface of second frame piece 110; this is since surfaces 156, 158 are preferably mirror images one of another, as discussed above. Alignment of first and second frame pieces 108, 110 when assembled into frame 102, is further assured by residence of male alignment guides 140 within female alignment grooves 142, where such guide-groove residence is indicated by numerals 166 in FIG. 13.

In the preferred embodiment, protrusions 136 and receptacles 138, together with male alignment guides 140 and female alignment grooves 142, are configured so that first and second frame pieces 108, 110 effectively snap together. This may be effectuated by protrusions 136 preferably having a slight mushroom cap shape, thereby providing slight interference with the lateral surfaces of receptacles 138 when protrusions 136 are pushed thereinto.

If first and second frame pieces 108, 110 are molded of plastic, which is preferable for construction of frame 102, protrusions 136 may be appropriately configured for snap together/pull-apart mating with receptacles 138. The characteristic of frame 102 and apparatus 100, whereby frame 102 may be separated after initial assembly by pulling first and second frame pieces 108, 110 apart, with such snap-together/pull-apart construction, permits refill or replacement of medication film or medicament pad 144. One suitable snap-together/pull-apart structure is the type used on the Lego molded plastic blocks. Other structural configurations may also be used to produce the snap-together/pull-apart feature.

In the most preferred embodiment of the invention, medicament pad 144 is preferably a dissolvable film of the type well-known for use in delivering antacid medications, breath fresheners and other therapeutic substances that are desirably introduced into one's mouth.

It is further within the purview of the invention that medicament film 144 may extend into passageway 120 by having one or both of depressions 118, 118A extend additionally somewhat transversely to handle 116, so as to provide additional, optionally recessed, space between facing surfaces 156, 158 for residence of medicament film 144 therein, with film 144 thereby overlapping into passageway 120 when frame 102 is assembled.

It is further within the purview of the invention to provide some toothpick-like structure with a point at mouthpiece end 104, in much the same manner as the embodiment illustrated in FIGS. 1 through 5.

When using apparatus 100, one typically retains floss and medicament holding end 106, to which the U-shaped structure is most proximate, in one's mouth, thereby permitting film 144 to dissolve and thereby deliver the medication to the user. Additionally, retaining floss and medicament holding end 106 of apparatus 100 in one's mouth means that floss 150 is proximate the teeth and ready to be used to floss one's teeth, thereby to remove plaque and other undesirable substances.

The following is claimed:

1. Apparatus facilitating dental floss-based tooth cleaning and oral and vaporous administration of medication, comprising:
a. a frame of two piece construction having an inhalation end and a floss and medicament holding end, comprising two pieces having mirror image surfaces adapted for facingly contacting securement one to another, each piece including:
i. a longitudinally elongated handle portion extending from the floss and medicament holding end to the inhalation end, including a longitudinally extending depression running the length of the handle portion, formed in the mirror image surface of the handle portion so that when the mirror image surfaces of the two handle portions complementally contact and overlie one another as the two pieces are assembled to define the frame, the facing depressions define an interior air drawing passage extending the longitudinal length of the handle;
ii. a U-shaped portion formed at the floss and medicament holding end having the base of the U defined by a portion of the handle remote from the inhalation end, legs of the U extending parallel and transversely from the handle and being adapted to retain dental floss stretched therebetween proximate the leg extremities that are remote from the handle portion defining the base of the U, the U-shaped portion being sufficiently small to fit easily into the mouth of an adolescent with the legs of the U being spaced apart more than width of a large male adult's 12 year molar;
iii. a plurality of protrusions and receptacles, with the protrusions being located on the mirror image surface of a first one of the pieces and the receptacles being located in and correspondingly positioned on the mirror image surface of the remaining one of the pieces, for receipt and retention of corresponding ones of the protrusions as the pieces are assembled into the frame the protrusions being adapted to puncture and retain a medicament web in place as the protrusions enter the receptacles when the web is positioned between and in facing contact with the mirror image surfaces of the pieces and the pieces are assembled into the frame;
b. dental floss connected to and extending between the legs of the U proximate extremities thereof that are spaced from the part of the handle forming the base of the U;
c. the medicament web having saliva-soluble orally administrable medication therein and being sandwiched between the mirror image surface portions of at least the legs of the U when the mirror image surfaces of the U-shaped portions facingly contact, with the web occupying longitudinally elongated space separating the legs of the U and extending transversely substantially to the base of the U, wherein the medication includes at least one of nicotine, a fluoride-based tooth enamel hardener, a breath freshener, a base for neutralizing stomach acid, a stomach acid inhibitor and a tooth enamel whitener.

2. Apparatus of claim 1 wherein the frame exterior surfaces are planar.

3. Apparatus of claim 1 wherein said frame has at least one planar exterior surface.

4. Apparatus of claim 1 wherein the depression is U-shaped.

5. Apparatus of claim 1 wherein the depression is V-shaped.

6. Apparatus of claim 1 wherein the depression comprises facing, convergingly sloping sides.

7. Apparatus facilitating dental floss-based tooth cleaning and oral and vaporous administration of medication, comprising:
a. a frame including:
i. an elongated handle extending from a floss and medicament holding end to a pointed toothpick end; and
ii. the floss and medicament holding end, having spaced-apart legs for retaining dental floss therebetween, the floss and medicament holding end being sufficiently small to fit easily into the mouth of an adolescent, the legs being longitudinally spaced sufficiently apart and adapted to tautly retain therebetween a length of dental floss greater than width of a large adult's 12 year molar;
b. a saliva-soluble orally administrable hygienic medication adapted to be secured in position between the legs; and
c. wherein at least one of the surfaces of the legs includes a first mating surface and the medication includes a second mating surface, the mating surfaces engaging one other to retain the medication in position between the legs when the medication is inserted thereinto.

8. Apparatus of claim 7 further comprising an interior air drawing tube extending the length of the elongated handle.

9. Apparatus of claim 7 wherein the first mating surface extends parallel to said handle.

10. Apparatus of claim 7 wherein the legs extend parallel with one another and transversely from the handle.

11. Apparatus of claim 7 wherein at least one of the two mating surfaces includes a groove.

12. Apparatus of claim 10 wherein the legs have mutually facing surfaces and the first mating surface is in at least one of the mutually facing surfaces of the legs.

13. Apparatus of claim 7 wherein said medication includes at least one of a nicotine-based anti-smoking substance, a fluoride-based tooth enamel hardener, a breath freshener, a base for neutralizing stomach acid, a stomach acid production and a tooth enamel whitener.

14. Apparatus of claim 7 further comprising dental floss adapted for connection to and tautly extending between the legs.

15. A frame for facilitating dental floss-based tooth cleaning and oral and vaporous administration of medication, comprising: two pieces with surfaces adapted for facingly contacting securement one to another to form the frame;
a. with each piece including a longitudinally elongated handle;
b. with at least one of the pieces including a portion formed proximate one end of the handle having legs extending parallel one with another and transversely from the handle and being adapted to tautly retain dental floss therebetween proximate leg extremities that are remote from the handle, the portion being sufficiently small to fit easily into the mouth of an adolescent with the legs being spaced apart more than width of a large male adult's 12 year molar;
c. with a plurality of male and female members located on facing surfaces of the pieces for mating engagement as the pieces are assembled into the frame, the male members being adapted to puncture, if needed, and to retain a medicament web in place with at least a portion of the web between the legs, as the male members enter the female members when the web is positioned between and in contact with the facing surfaces of the pieces and the pieces are assembled into the frame.

16. Apparatus of claim 15 wherein the surfaces adapted for facingly contacting securement are mirror images of one another.

17. Apparatus of claim 15 further comprising an interior air drawing passage extending the longitudinal length of the handle when the surfaces of the two pieces are in facingly contacting securement one to another.

18. Apparatus of claim 15 wherein the frame exterior surfaces are planar.

19. Apparatus of claim 15 wherein said frame has at least one planar exterior surface.

20. Apparatus of claim 15 wherein the first facing surface extends parallel to said handle.

21. Apparatus of claim 15 wherein at least one of the two facing surfaces includes a groove.

22. Apparatus facilitating dental floss-based tooth cleaning and oral and vaporous administration of medication, comprising:
a. a frame of two piece construction having an inhalation end and a floss and medicament holding end, having two pieces adapted for snap-together contacting securement one to another, comprising:
i. a longitudinally elongated handle portion extending from the floss and medicament holding end to the inhalation end, including an interior air drawing passage extending the longitudinal length of the handle;
ii. a U-shaped portion formed at the floss and medicament holding end having a base of the U defined by a portion of the handle remote from the inhalation end, legs of the U extending parallel and transversely from the handle and being adapted to retain dental floss stretched therebetween, the U-shaped portion being sufficiently small to fit easily into the mouth of an adolescent with the legs of the U being spaced apart more than width of a large male adult's 12 year molar;
iii. a protrusion and a receptacle on respective ones of the pieces, with pieces being adapted to retain a medicament web in place therebetween as the protrusion snaps into the receptacle when the web is positioned between and in contact with the pieces as the pieces are assembled into the frame.

23. Apparatus of claim 22 further comprising dental floss connected to and extending between the legs of the U.

24. Apparatus of claim 23 wherein the medicament web has saliva-soluble orally administrable medication therein and is sandwiched between portions of at least the legs of the U when surfaces of the U-shaped portions facingly contact, with the web occupying longitudinally elongated space separating the legs of the U and extending transversely substantially to the base of the U.

25. Apparatus of claim 24 wherein the medication includes at least one of a nicotine-based drug to promote smoking cessation, a fluoride-based tooth enamel hardener, a breath freshener, a base for neutralizing stomach acid, a stomach acid inhibitor and a tooth enamel whitener.

26. A dental floss-based tooth cleaning and oral and vaporous medication administration product, comprising a package having included therein:
a. a frame constructed of two pieces adapted for contacting snap-together securement and pull-apart disengagement respecting one another, the frame comprising:
i. a longitudinally elongated handle;
ii. a U-shaped portion having a base of the U defined by a portion of the handle, legs of the U extending parallel and transversely from the handle, being longitudinally spaced and adapted to retain dental floss stretched therebetween, the U-shaped portion being sufficiently small to fit easily into the mouth of an adolescent with the legs of the U being spaced apart more than width of a large male adult's 12 year molar;
iii. a protrusion and a receptacle on respective ones of the pieces, with the pieces being adapted to retain a medicament web in place therebetween as the protrusion snaps into the receptacle with the web is positioned between and in contact with the pieces as the pieces are assembled to provide the frame;
b. dental floss adapted for connection to and extending between the legs of the U;
c. a medicament web having saliva-soluble orally administrable medication therein, adapted to be sandwiched between portions of at least the legs of the U when surfaces of U-shaped parts of the two pieces facingly contact, with the web substantially occupying longitudinally elongated space separating the legs of the U and extending transversely substantially to the base of the U;
d. wherein the medication includes at least one of a nicotine-based drug to promote smoking cessation, a fluoride-based tooth enamel hardener, a breath freshener, a base for neutralizing stomach acid, a stomach acid inhibitor and a tooth enamel whitener.

27. A frame for facilitating dental floss-based tooth cleaning and oral and vaporous administration of medication, comprising: two pieces adapted for securement one to another to form the frame;
a. including a longitudinally elongated handle;
b. with at least one of the pieces including a portion formed proximate one end of the handle having legs extending from the handle adapted to retain dental floss therebetween, the portion being sufficiently small to fit easily into the mouth of an adolescent with the legs being spaced apart more than width of a large male adult's 12 year molar;
c. male and female members located on surfaces of the pieces for engagement as the pieces are secured to form the frame, the male members being adapted to puncture, if needed, and to retain a medicament web as the male members enter the female members and the pieces are assembled into the frame.
